(19) United States
(12) Patent Application Publication
(10) Pub. No.: US 2023/0242201 A1
(43) Pub. Date: Aug. 3, 2023

(54) VEHICLE, MORE PARTICULARLY A LIGHTWEIGHT VEHICLE

(71) Applicant: Günter Rood, Husum (DE)

(72) Inventor: Günter Rood, Husum (DE)

(21) Appl. No.: 17/923,398

(22) PCT Filed: Apr. 23, 2021
(86) PCT No.: PCT/EP2021/060634

§ 371 Date: Nov. 4, 2022

(30) Foreign Application Priority Data
May 5, 2020 (DE) 10 2020 002 670.2
Jun. 3, 2020 (DE) 10 2020 114 696.5

(51) Int. Cl. B62J 17/08; B62K 11/02; B62K 5/05; B62K 15/00

(52) U.S. Cl. CPC B62J 17/08; B62K 11/02; B62K 5/05; B62K 15/00

(57) ABSTRACT

A light vehicle with at least one vehicle seat, a front wheel structure having at least one wheel, a rear wheel structure having at least one wheel, and a drive device for movement of the vehicle, wherein the vehicle is reversibly transferable from a driving configuration during driving of the vehicle into a transport and/or parking configuration with reduced spatial dimensions of the vehicle compared with the driving configuration, in particular a reduced distance between the front wheel structure and the rear wheel structure, and/or the vehicle seat being set up in a driving configuration and in a transport and/or parking configuration for seating a driver on a seat surface of the vehicle seat. A shield for a driver is provided, wherein the shield shields the body of the driver upwardly and/or to the sides from the environment at least in regions when sitting on the vehicle seat.

### CROSS-REFERENCE TO RELATED APPLICATIONS

The present application is the U.S. national stage application of International Application PCT/EP2021/060634, filed Apr. 23, 2021, which international application was published on Nov. 11, 2021, as International Publication WO 2021/224022 A1. The international application claims priority to German Patent Application No. 10 2020 002 670.2, filed May 5, 2020, and to German Patent Application No. 10 2020 114 696.5, filed Jun. 3, 2020.

### FIELD

The invention relates to a vehicle, in particular a light vehicle, with at least one vehicle seat, preferably with only one vehicle seat or with only two vehicle seats, with a front wheel structure having at least one wheel, with a rear wheel structure having at least one wheel, and with a drive device for, in particular, motorized movement of the vehicle, wherein, preferably, the vehicle being reversibly transferable from a driving configuration during driving of the vehicle into a transport and/or parking configuration with reduced spatial dimensions of the vehicle compared with the driving configuration, in particular a reduced distance between the front wheel structure and the rear wheel structure, and/or the vehicle seat in a driving configuration and in a transport and/or parking configuration being set up for seating a driver on a seat surface of the vehicle seat.

### BACKGROUND

In terms of ecological as well as economic aspects, serious changes are taking place very quickly in the field of transportation. This applies in particular to passenger transport. In order to meet current and future requirements, it is necessary to find a good compromise between the general need for sustainability and the individual desire for comfort and safety. Increased use of local public transport services often fails due to a lack of acceptance among large sections of the population. The aspect of the so-called “first and last mile” is seen as particularly problematic. While central locations are generally well connected to the public transport network, the journey from the actual starting point, such as the home, to a central transport hub, as well as from such a hub to the final destination of a trip, is generally associated with increased effort. This is especially true in rural areas, but even affects metropolitan areas. Often, the effort to cover the first and last legs of a journey on foot or by changing trains several times is considered disproportionately high. A correspondingly extensive expansion of the existing public transport infrastructure to ensure accessibility almost everywhere with minimal effort is usually ruled out for economic reasons. As a result, even fundamental advocates of public transport often prefer private motorized transport (MIV).

Combined solutions, for example by traveling part of the way by bicycle and taking the bicycle on public transport, often fail because it is by no means possible to take a bicycle or a comparably sized means of transport on all public transport without problems. This is often already problematic for individual transport. The additional transport of an expected large number of bicycles, scooters or the like is ultimately not feasible with the current infrastructure of public transport. In any case, a bicycle or the like ultimately represents a comparatively bulky piece of luggage during locomotion by public transport. It is true that a folding bicycle, for example, can be folded for space-saving transport. However, this process is usually labor-intensive and time-consuming, especially if there are several bicycles, which can also always conflict with other passengers, and is therefore hardly worthwhile when using public transport for short or medium distances.

Alternative systems that allow for the collective transportation of individual vehicles, similar to a motorail train, are generally expensive and insufficiently available due to the associated space requirements.

A wide variety of small and/or light vehicles are already known from the state of the art, which are envisaged in sustainable transport concepts as environmentally friendly and space-saving means of transport. The acceptance of such small vehicles by the general public is low because there is often inadequate protection against the weather and the use of such vehicles is met with safety concerns by the general public. Another disadvantage is that the individual comfort zone available when driving in conventional passenger cars is not realized to a comparable extent when driving in small or light vehicles.

Against this background, it is the task of the present invention to provide a vehicle, in particular a light vehicle, of the type mentioned at the outset, which meets with a higher level of acceptance in large sections of the population and, in particular, satisfies high requirements in terms of weather protection and accident prevention. In addition, the vehicle is intended to create in a simple manner the possibility of forming an individual comfort zone for a driver and to contribute to establishing and implementing alternative traffic concepts.

### SUMMARY

The aforementioned problem is solved by a vehicle having the features of claim 1. Advantageous embodiments of the invention are the subject of the subclaims.

According to the invention, a shielding is provided and/or can be formed, wherein the shielding shields the driver from the environment when sitting on the vehicle seat in an upward direction and/or to the sides, at least in certain areas. The shielding can be designed as a partial body shielding and only shield certain parts of the driver's body from the environment, in particular the head area. In addition, however, the shielding may also shield other body parts or areas, such as the upper body/torso and/or the limbs of the driver. The shielding can shield the driver upwards and/or to the sides, whereby, preferably, the shielding does not form a passenger cell that is completely closed off from the surroundings. In principle, however, it is also not excluded that a substantially closed passenger cell is created.

The shielding according to the invention can intercept driving wind as weather protection and keep precipitation away from the driver. The shielding can also increase driving safety and contribute to better accident protection, with the shielding reducing the risk of injury in the event of a fall or frontal impact. Parts of the shielding can act as rollover protection and further increase driving safety. If the shielding forms a safety cell, if necessary with other vehicle parts, a helmet requirement when driving the vehicle according to the invention can be omitted. Finally, the shielding can provide hygiene protection against germs from the environment.

Last but not least, the shielding can also create an individual comfort zone for the driver, which is perceived as very pleasant in particular when the vehicle is transported only slightly adjacent to other vehicles and/or persons, for example when transporting the vehicle in a collective means of transport, such as a public means of transport, and/or in a parking condition next to other vehicles. A large-capacity means of transport thus becomes a private/individual means of transport or compartment.

Particularly preferably, the shield can be reversibly transferred from a non-functional configuration to the functional configuration, wherein the shield has different geometric dimensions in the non-functional configuration than in the functional configuration and/or is arranged differently relative to the driver in the non-functional configuration than in the functional configuration. The term “functional configuration” refers in particular to an operational state of the shielding. A vehicle seat, on the other hand, may preferably always be in a functional configuration, i.e., used for sitting, regardless of the configuration of the shielding.

The shielding may have a different size shielding surface and/or a different arrangement of the shielding surface relative to the driver's body in the non-functional configuration and in the functional configuration.

Another aspect of the invention provides that the shielding area can be increased or decreased as needed by replacing the shielding, in particular depending on the needs of an operator of a transfer vehicle. The shielding is then detachably connected to the vehicle and can be replaced with another shielding having a larger or smaller shielding area.

It is also possible that the shielding only shields the driver's body from the environment in the functional configuration, at least in certain areas, and is stowed away and/or folded up in the non-functional configuration, for example. However, an embodiment in which the shielding also shields certain areas of the body in the non-functional configuration is not ruled out, whereby further areas of the body can then be additionally shielded by the shielding in the functional configuration.

In addition, the shield can be reversibly transferred from the non-functional configuration to the functional configuration, for example, by pivoting or sliding, so that the shield is positioned differently relative to the driver's body and/or the vehicle seat in the two configurations and does not obstruct the driver in the non-functional configuration.

In a driving configuration of the vehicle according to the invention and in a transport and/or parking configuration of the vehicle, the vehicle seat can each have or form a seat surface for sitting, wherein the shielding can be provided or formed in both configurations for shielding the body at least in areas. In the driving configuration, the shielding then fulfills in particular the function as weather and/or accident protection, while in the transport and/or parking configuration, the shielding can fulfill a hygiene protection function and/or serve to form a private sphere for the driver. In the transport and/or parking configuration, the distance between the front wheel assembly and the rear wheel assembly of the vehicle may be smaller than in the driving configuration.

The distance between the wheel assemblies in the transport and/or parking configuration is preferably dimensioned in such a way that a stable standing of the vehicle is ensured. This applies in particular to the case where a user sits on the seat surface of the vehicle in the transport and/or parking configuration. A stable stance is to be assumed in particular if overturning of the vehicle only occurs when the vehicle tilts against the vertical axis by at least 10°, preferably at least 20°.

The possibility of converting the vehicle into a space-saving seating option with little effort allows, in particular, the vehicle to be taken along on public transport without requiring significantly more space than an ordinary seat on a bus or train would take up anyway. As a result, the present invention allows the vehicle to be seamlessly integrated into local and/or long-distance public transportation services by using public transportation cars that are provided at least partially empty or without seats. A passenger who has traveled with the vehicle according to the present invention, for example to a public transport stop, can thus use his vehicle in the public transport system as his own seating. In contrast, there are no further space requirements, in particular for stowing the vehicle, as in the case of a bicycle or the like. This is particularly advantageous in the case of many vehicles. As a result, a major hurdle to linking public and individual passenger transport is removed.

Using one's own seat also eliminates the problem of passengers having to sit on dirty or damaged seats of the means of transport. In addition, by using an individual, preferably ergonomic seat, the seating position and thus the comfort for the user can be adjusted and is maintained during the journey by public transport. This has particular advantages for people who have special requirements for their seat for medical reasons. Modern reservation systems also make it possible to control and equalize the flow of passengers even at rush hour times. In the case of collective transport on trains, the additional demand can be compensated for by an increased number of trains and shorter intervals, which in turn can be ensured by spacing systems.

It goes without saying that the vehicle according to the invention offers advantages not only in local and long-distance public transport. The efficient use of non-public carrier vehicles, for example in the private sector or in the transport of security and emergency personnel, is also made possible by the invention. However, widespread use in public passenger transport, especially in local public transport, has the greatest influence on positive ecological development. Therefore, this application is particularly emphasized here. All embodiments and advantages of the invention described with respect to the public sector apply in the same or corresponding manner to the non-public sector.

Preferred embodiments of the invention are presented below. The vehicle according to the invention may have one or more of the described features in any combination.

The vehicle may have an adjustment device for changing the distance between the front wheel assembly and the rear wheel assembly.

In addition to the driving configuration and the transport and/or parking configuration, the vehicle can be transferred to a further configuration. Preferably, in the further configuration the distance between the front wheel assembly and the rear wheel assembly is even smaller than in the transport and/or parking configuration and/or the external dimensions of the vehicle are further reduced in at least one dimension. In particular, projecting parts of the structure, for example a seat surface, can be removed, folded in and/or retracted for this purpose, resulting in an overall more compact shape of the vehicle in the further configuration.

The distance between the front wheel assembly and the rear wheel assembly in the transport and/or parking configuration and/or in the further configuration may be less than the width of the vehicle.

The vehicle can have a multi-part body with at least two vehicle sections connected to one another, in particular in an articulated and/or displaceable manner, preferably with the front wheel body being assigned to a front vehicle section and the rear wheel body being assigned to a rear vehicle section. Several vehicle sections, in particular vehicle frame parts, can also be foldably connected to one another.

Reducing the wheelbase ultimately reduces the footprint of the vehicle when it is transferred from the driving configuration to the transport and/or parking configuration. This significantly reduces the space required in any collective transport vehicle.

The drive means of the drive unit can be designed as an electric motor. This enables the vehicle to be propelled almost silently. A hydrogen engine is also possible. The drive unit can also be a pedal crank drive.

A fuel cell can be assigned to the drive means.

In particular, the drive unit can implement a plurality of drive concepts in parallel in the sense of a hybrid drive.

The drive device acts in particular on the wheels of the rear or front wheel assembly. Preferably, both at least one wheel of the front wheel assembly and at least one wheel of the rear wheel assembly, especially preferably all wheels, are driven.

The drive means may be configured to accelerate the vehicle to a speed of at least 5 km/h, preferably at least 10 km/h, preferably at least 25 km/h, more preferably at least 45 km/h.

Alternatively or additionally, the vehicle can also be configured not to exceed a certain maximum speed. This is done in particular by means of a corresponding cruise control. Preferably, the maximum speed is a maximum of 6 km/h, preferably a maximum of 12 km/h, further preferably a maximum of 20 km/h. Depending on the typical application situation of the vehicle, a higher limitation of the maximum speed, for example to a maximum of 30 km/h, a maximum of 50 km/h or a maximum of 60 km/h, can also be provided.

An energy storage device, in particular a battery, an accumulator or the like, can be provided from which the drive device is supplied with energy. A control device can be provided to monitor the state of charge and any charging process. The energy storage device can be charged, in particular, by connecting the vehicle to the supply network, for example to a standard household socket. Charging and/or diagnostics of the energy storage device can be performed in particular after the vehicle has been coupled to a collective transport means by means of a suitably designed coupling device. The energy storage unit can also be formed or supplemented by a fuel tank.

The energy storage unit preferably has a sufficient storage volume to allow driving without recharging, refilling or replacing the energy storage unit over a distance of at least 50 km, preferably at least 100 km.

The distance between the front wheel assembly and the rear wheel assembly in the driving configuration can be at least 1 m, preferably at least 1.5 m.

The vehicle may have an open structure or comprise a passenger cell. The passenger cell can be designed to be completely or partially removable and/or closable or lockable. The passenger cell may thereby be shieldable from the environment at least partially and in at least one spatial direction, i.e. upwardly and/or toward the sides, by the shielding provided according to the invention.

According to the invention, the shielding can be movably, in particular displaceably and/or pivotably, connectable and/or connected to the vehicle, in particular the vehicle seat and/or a chassis of the vehicle. This enables reversible transfer of the shielding from a functional state to a non-functional state and back in a simple manner.

Furthermore, the shielding can be detachably connectable and/or connected to the vehicle. This makes it possible in a simple manner to separate the shield from the vehicle, for example when no shield is required and/or when using high-quality shields, in order to avoid theft of the shield.

It is expedient if the vehicle, in particular the vehicle seat, has a storage space for at least partial stowage of the shielding in the non-functional state of the shielding, further in particular in the region of a seat back and/or a headrest of the vehicle seat. The shield may be extendable upwardly and/or laterally from the stowage space to transfer the shield from a non-functional state to the functional state. In the non-functional state of the shield, the shield may then be received in the storage space, preferably substantially completely so as to preclude obstruction of the driver when the shield is not in use. In the non-functional state of the shield, the shield may be integrated, for example, into a backrest and/or headrest of the vehicle seat, so that the shield is not perceived from the outside or is not perceived in a disturbing manner.

Preferably, the shielding is designed in several parts, wherein shielding parts of the shielding can be connected to one another in a displaceable and/or pivotable manner for transfer from the non-functional configuration to the functional configuration, in particular wherein the shielding can be extended in a segment-like manner. By displacing and/or pivoting the shielding parts, the shielding area can be enlarged or reduced as required, or additional shielding areas, for example upper and/or lateral shielding areas, can be formed as required in order to shield the driver's body from the environment.

A structurally simple embodiment provides for shielding parts of the shielding to be displaceable along guide rails. This makes it easy to transfer the shielding from a non-functional configuration to the functional configuration and back. In addition, the guide rails can contribute to accident protection and, for example, form a rollover protection.

In particular, the shielding area of the shielding can be changed as required by moving and/or pivoting shielding parts, whereby several functional configurations of the shielding are also possible in which the shielding area is of different sizes.

A preferred embodiment of the invention provides that the shielding in the functional configuration forms a canopy and separates at least parts of the body upwardly from the surroundings, wherein, preferably, the shielding can extend in the longitudinal direction of the vehicle from the rear wheel structure to, further preferably, the front wheel structure. In principle, however, it is also possible for the shielding to provide lateral protection in the manner of lateral partitions.

The shielding may extend in the longitudinal direction of the vehicle from the vehicle seat to the front wheel assembly so that, in the functional configuration, the head, torso and limbs of the body are covered and/or laterally shielded.

In this context, the shielding in the functional configuration can cover the body of the driver, in particular in an arc-shaped manner, wherein correspondingly designed arc-shaped guide rails can be provided for several shielding parts, which are moved in a segment-like manner by pulling apart or sliding apart relative to one another along the guide rails in order to change the shielding surface or the shielded body areas of the driver.

In this context, a preferred embodiment of the invention provides that the shielding comprises a plurality of preferably arcuate shielding segments which are displaceable along preferably arcuate guide rails. The shielding segments may be superimposed in a non-functional state of the shielding. To transition the shielding to the functional configuration, the shielding segments may then be slidable in succession along the guide rails and relative to each other to form a substantially closed shielding surface. In the non-functional configuration, the shielding segments can be arranged or stacked one on top of the other, and there is the further option of pivoting the formed stack of segments upwards by means of an articulated connection to the vehicle, in particular to the vehicle seat or the guide rails, and pushing or inserting it into a corresponding receptacle of the vehicle seat, in particular in the region of the backrest.

In the non-functional state, the shielding is preferably located behind the driver's body and thus cannot interfere with the driver's freedom of action and movement.

In the driving configuration, the vehicle may have a body shape of a scooter, in particular a two-wheeled scooter, a runabout or buggy, or a tricycle. In addition, a go-kart-like body shape is also preferred.

The vehicle may be in the nature of a bicycle with two or three or four wheels. In addition, the vehicle may have twin tires.

The vehicle may comprise a seat, in particular a centrally arranged seat. In addition, a design with a plurality of seats is also possible within the scope of the invention. Alternatively or additionally, an open or preferably separately lockable storage space for transport material may be provided.

In particular, the seat comprises a seat surface and a seat back. Preferably, the seat is at least partially usable both in the driving configuration and in the transport and/or parking configuration by a person sitting on the seat surface. Preferably, the seat position and/or the seat shape is adjustable.

Control devices are provided in particular for controlling the vehicle during driving. These include, for example, a steering system, preferably in the form of a steering knuckle. The steering can be operated mechanically via a steering column and steering means, or it can be controlled electronically. The steering can also be controlled via an input device, such as a joystick, particularly in a vehicle with an electric drive. Mechanically, traction cables may be provided to operate the steering. There is also the possibility of being able to steer the vehicle when it is driven by wind, like a beach sailer, using a sail adjuster.

In principle, the vehicle is not limited to a particular steering technology. Alternatively or additionally, steering technologies known from recumbent bicycles or velomobiles, for example, can be implemented, in particular a tank steering system, a bottom steering system, a top steering system or a UDK (“around the knees”) steering system or a so-called aero steering system.

Similarly, control elements for accelerating and decelerating the vehicle can also be based on a mechanical or electronic operating principle or implement a mixture of both concepts. In particular, mechanically acting elements such as a steering column and/or pedals are designed in such a way that they can be retracted and/or swung away during the transition from the driving configuration to the transport and/or parking configuration and/or a further configuration for stowing the vehicle.

A coupling device can be provided for coupling the vehicle to a corresponding coupling receptacle, in particular a coupling receptacle of a collective transport means. The collective transport means is in particular a bus, a train, a ferry or a cable or gondola lift. The coupling device can be designed, in particular standardized, for coupling the vehicle to several different collective transport means.

The coupling device is in particular part of a coupling system. The coupling system may comprise, on the side of the collective transport means, a single receptacle for the coupling device or a rail system for connection to one or more coupling devices. The coupling device as such may further comprise a hook arrangement for connection to a corresponding receptacle. Alternatively or additionally, the coupling device can be designed to be connected to a receptacle, in particular a standardized receptacle, according to the principle of a docking station.

By using a collective transport vehicle, greater distances can be covered in a more economical and ecologically compatible manner than would normally be possible by private transport. In this context, the vehicle according to the invention serves in particular to bridge the so-called “first and last mile”, i.e. in each case the distances between the exact starting point or destination and the access point to the collective transport means, which serves as a means of transport for the main part of the distance to be covered between the starting point and destination.

The vehicle can have a handle element that can be pulled out in particular.

A locking device for locking at least one wheel, preferably all wheels, can be provided.

The locking device can be activated by transferring the vehicle to the transport and/or parking configuration.

The locking device can be activated and/or deactivated alternatively or additionally by an operating device arranged in particular on the handle element.

The vehicle may include a preferably extendable or swing-out support device for stabilizing the vehicle in a standing position, particularly in the parking and/or transport configuration.

In another preferred embodiment of the invention, the shielding may also be in the form of a helmet-like or hood-like head protection and substantially shield the head and, preferably, the neck and portions of the upper body from the environment.

In the last embodiment described, the shield may comprise a hinged or sliding visor substantially shielding the driver's face. The visor may be indirectly or directly hingedly connected or connectable to the vehicle, particularly the vehicle seat.

In a preferred embodiment, the shield may comprise a head part shielding substantially the back of the head and/or the upper head region at least partially, wherein, further preferably, the head part is fixedly connected and/or connectable to the vehicle, in particular the vehicle seat. The head part may form an integral part of the vehicle seat and/or a head rest. An abutment surface in the head part for the driver's head can preferably merge smoothly into a leaning surface of a backrest of the vehicle seat and/or form an extension of the leaning surface. The headrest can also be detachably connected to the vehicle seat, in particular be insertable into the vehicle seat from above, as is provided in headrests of vehicles of conventional design.

A visor of the shielding may be pivotably and/or slidably connected to the head part, as is usually the case with motorcycle or astronaut helmets. In the functional configuration of the shield, the visor may then be closed and shield the driver's face from the environment. In contrast, in a non-functional configuration, the visor may be flipped up or raised or moved laterally out of the face area, exposing the driver's face. The back of the driver's head and/or upper head region and/or cheeks, on the other hand, may be at least partially separated from the environment in the non-functional configuration by the head portion, which is preferably stationarily connected to the vehicle seat. The helmet-like shielding thus fulfills a shielding effect against the environment in the non-functional configuration and also in the functional configuration in equal measure.

In the case of a helmet-like design of the shielding, free movement of the head is particularly advantageous, especially even when a visor of the shielding is closed. Accordingly, the internal dimensions of the shields may be dimensioned such that it is possible for a driver to move the head freely when in the sitting position, in the driving configuration and, preferably, also in a parking and/or transport configuration of the vehicle according to the invention.

In the case of a helmet-like design of the shield, this can have a swiveling bracket as an edge boundary for the visor, whereby, preferably, the bracket is attached to a head part of the shield so that it can swivel independently of the visor. Multimedia and/or communication devices may be integrated into the yoke. Input means on the yoke can be used to access social media. Also, two pivoting temples may be provided that are associated with different halves of the face. Preferably, the temples can pivot open independently of each other. The temples can also perform a safety function for the driver's head and a protective function for a visor.

In order to adapt a helmet-like shield to the seat size of the driver, the shield, in particular the head part, can be attached to the vehicle, in particular to the vehicle seat, in a vertically adjustable manner in terms of height. Furthermore, the shielding, in particular the head part, can be rotated around a vertical axis. This opens up the possibility of swiveling the shielding out of the seat area as needed and thus moving it out of the driver's close range. This can ensure that the driver is not obstructed by the shielding. If the shielding comprises a head part and, preferably, a visor attached to the head part, the head part may be height-adjustably and/or pivotably attached or attachable to a headrest of the vehicle seat. The fastening can, for example, take place via threaded rods, latching/sliding rods. Fastening via belts is also possible.

Another embodiment of the vehicle according to the invention can provide a shielding which is designed as a flexible, in particular reversibly inflatable hood. In this way, a protective function of the shielding can be realized in a simple manner, whereby a plastic material, in particular a film material, of suitable thickness can preferably be used as the hood material. By using a flexible material, of which the shielding consists at least in parts, a high wearing comfort can be achieved and, when the body comes into contact with the hood, injuries caused by the yielding material of the shielding can be largely excluded. In an uninflated collapsed state, the shielding can be integrated into a storage space in the vehicle seat, in particular into a headrest and/or a backrest, with little effort. The shield can then be manually removed from the storage space when a shield is needed. For automatic inflation of the hood, a blower or a compressor can be provided and, also preferably, integrated into the vehicle seat. In particular, the hood can be reversibly converted from a non-functional configuration to a functional configuration several times by inflating and deflating air.

To create a pleasant private atmosphere for the driver, the shielding can have a multimedia device, a noise reduction device, a lighting device and/or a device for emitting fragrances. In this way, the shielding meets the highest comfort requirements.

The previously described aspects of the vehicle according to the present invention can be combined with each other as needed, even if this is not explicitly described in detail. The previously described features and aspects of the present invention may be combined with the aspects and features described below with reference to the drawing, as needed.

### BRIEF DESCRIPTION OF THE DRAWINGS

Embodiments of the invention are further described below with reference to the drawing. The invention is not limited to the embodiments shown in the drawing and described with reference to the drawing. In the drawing show

FIG. 1 is a schematic partial view of a vehicle according to the invention with a shield to be designed in the form of a roof for a driver of the vehicle when sitting on a vehicle seat, the shield being shown in a stowed non-functional configuration,

FIG. 2 illustrates the vehicle from FIG. 1, with the shielding shown in a first functional configuration,

FIG. 3 illustrates the vehicle of FIG. 1, with the shielding shown in a second functional configuration,

FIG. 4 illustrates the vehicle from FIG. 1, with the shielding shown in a third functional configuration,

FIG. 5 is a schematic partial view of a further vehicle according to the invention with a helmet-like shield for a driver of the vehicle when sitting on a vehicle seat,

FIG. 6 is a perspective view of the shield of FIG. 5, showing the shield in a first functional configuration,

FIG. 7 is a perspective view of the shield of FIG. 5, showing the shield in a second functional configuration,

FIG. 8 is a perspective view of the shield of FIG. 5, showing the shield in a third functional configuration,

FIG. 9 is a perspective view of the shield of FIG. 5, showing the shield in a non-functional configuration with the visor open,

FIG. 10 is a schematic partial view of a third vehicle according to the invention with a shield to be formed in a hood-like manner for a driver of the vehicle when sitting on a vehicle seat, the shield being shown in a non-functional configuration, and

FIG. 11 illustrates the vehicle of FIG. 10, with the shielding shown in a functional configuration.

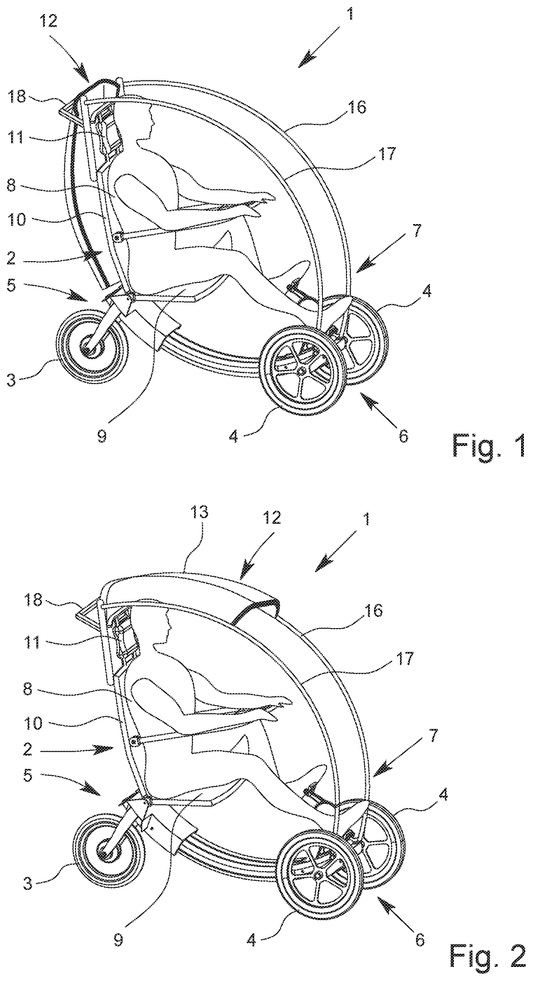

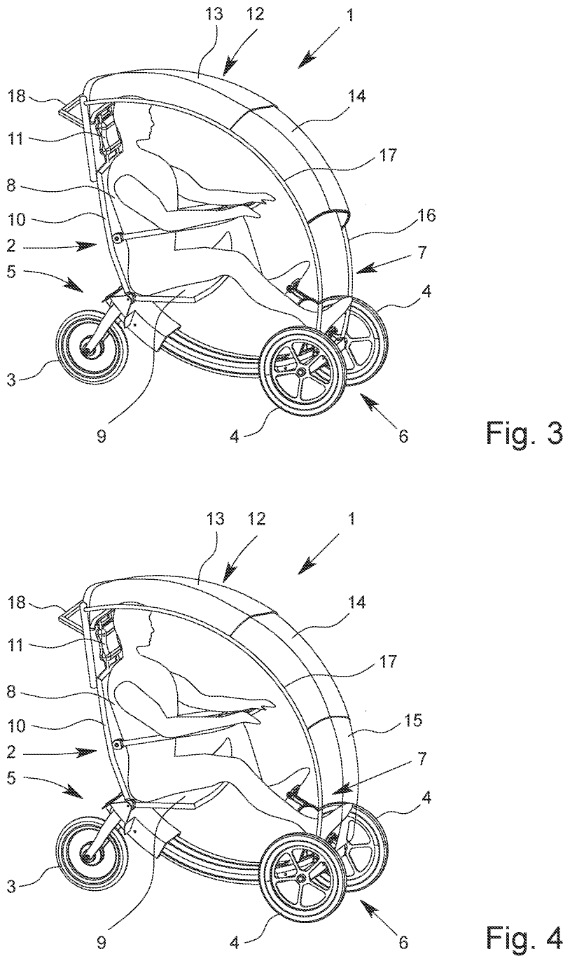

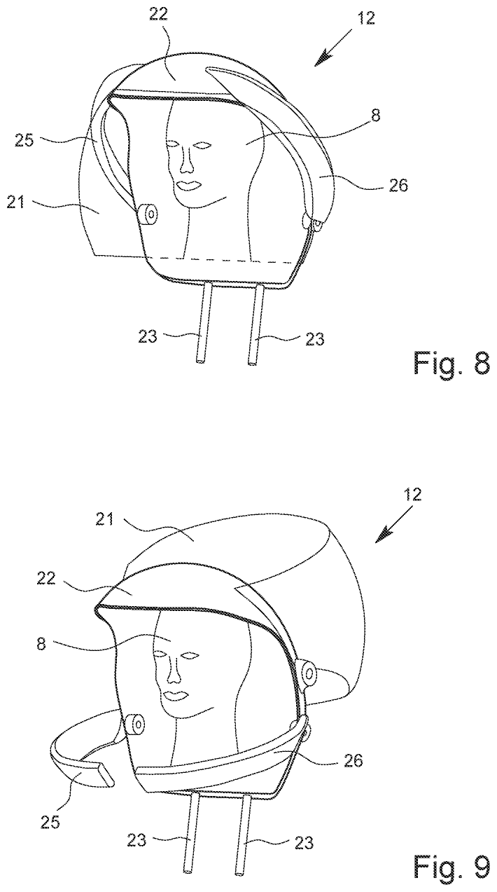

Features, components and/or assemblies of the following embodiments of the invention shown in FIGS. 1 to 12 which are identical in function and/or nature are marked with the same reference signs.

### DETAILED DESCRIPTION

FIGS. 1 to 4 show a vehicle 1, in particular a light vehicle, which has, by way of example, only one vehicle seat 2, one rear wheel 3 and two front wheels 4. The rear wheel 3 is attached to a rear wheel assembly 5 and the front wheels 4 are attached to a front wheel assembly 6. Not shown in detail is that a drive device may be provided for moving the vehicle 1, in particular independently. In addition, a pedal crank drive 7 is provided for driving the vehicle 1 with muscle power.

FIGS. 1 to 4 schematically show a driver 8 sitting on a seat surface 9 of the vehicle seat 2. The state of the vehicle 1 shown in FIGS. 1 to 4 particularly reflects a driving configuration of the vehicle 1 when the vehicle 1 is moved by motor and/or muscle power. Here, the driver 8 can lean with his back against a backrest 10 of the vehicle seat 2. A headrest 11 can be provided to support the head of the driver 8.

The vehicle 1 shown in FIGS. 1 to 4 has a shielding 12 for the driver 8 when sitting on the seat surface 9, wherein the shielding 12 in at least one functional configuration shields the body of the driver 8 upwardly and also regionally to the sides from the surroundings. FIG. 1 shows the shielding 12 in a non-functional configuration, in which the shielding 12 does not perform a shielding effect. FIGS. 2 to 4 show the shielding 12 in different functional configurations, which differ in the size of the shielding area formed by a plurality of segment-like shielding parts 13, 14, 15 of the shielding 12.

The shielding 12 described below on the basis of vehicle 1 can also be provided on vehicles that have a different structural design.

The shield 12 is reversibly convertible from the non-functional configuration shown in FIG. 1 to any of the functional configurations shown in FIGS. 2 through 4. The shield 12 has different geometric dimensions in the non-functional configuration than in each of the functional configurations, and is positioned differently relative to the driver 8 in the non-functional configuration than in each of the functional configurations.

As can be seen from a comparison of FIGS. 2 to 4, the shielding 12 is exemplarily formed by the three shielding parts 13, 14, 15, which are displaceable along guide rails 16, 17. Due to the guide rails 16, 17, a high torsional stiffness of the overall construction is achieved.

As already described above, the total shielding area of the shielding 12, which spans the body of the driver 8 in a roof-like manner, can be enlarged or reduced as required by moving or pulling apart the shielding parts 13, 14, 15. As can be seen in particular from FIG. 4, when all three shielding parts 13, 14, 15 are pulled apart, the shielding 12 extends from the rear wheel assembly 5 to the front wheel assembly 6 so that the head, torso and limbs of the body of the driver 8 are roofed over.

In particular, the arcuate shielding 12 of the driver 8 in the functional configuration shown in FIG. 4 ensures a high degree of weather and accident protection for the driver 8.

It is not shown that, in addition to the roof-like shielding 12 of the driver 8 provided in FIGS. 1 to 4, a lateral shielding may be provided. Nor is it excluded that the shielding 12, in conjunction with other shielding components, may form a substantially enclosed vehicle cabin.

In the non-configuration state of the shielding 12 shown in FIG. 1, the shielding parts 13, 14, 15 are pushed into one another and can then be arranged as a parts package in the area behind the driver 8. For this purpose, a retaining bracket 18 is provided on the rear side of the vehicle seat 2, in which the parts package formed by the shielding parts 13, 14, 15 can be accommodated.

The holding of the shielding parts 13, 14, 15 via the retaining bracket 18 is selected merely as an example.

Differently designed holding devices for the shielding 12 in the folded non-functional state can be provided, in particular for holding the shielding 12 behind the vehicle seat 2. The arrangement of the shielding 12 in the area behind the vehicle seat 2 is advantageous and basically independent of the structural design of the shielding 12.

For example, a substantially closed or closable receiving or storage space for the shielding 12 may be formed in particular behind the backrest 10. The receiving or storage space can be formed in the backrest 10, so that the shielding 12 can be substantially completely integrated into the backrest 13 and is not perceived from the outside in a disturbing manner.

The vehicle 1 shown in FIGS. 1 to 4 can be converted from the driving configuration shown for driving the vehicle, in particular by changing the distance between the rear wheel assembly 5 and the front wheel assembly 6, into a transport and/or parking configuration in which the vehicle 1 has reduced space dimensions. Preferably, the vehicle seat 2 can be used equally well both in the driving configuration of the vehicle 1 shown in FIGS. 1 to 4 and in the transport and/or parking configuration of the vehicle 1. In the transport and/or parking configuration 1, the vehicle 1 can then be transported in particular by a collective transport vehicle, such as a bus or a rail-guided vehicle.

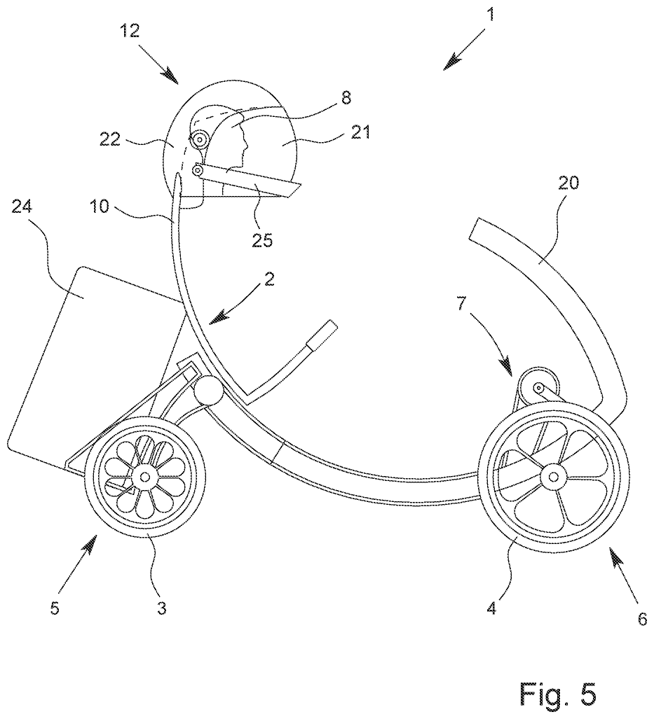

FIGS. 5 to 9 show a further embodiment of a vehicle 1, in particular designed as a light vehicle, which, preferably, is reversibly transferable from a driving configuration for driving the vehicle, as shown in FIG. 5, to a transport and/or parking configuration with reduced spatial dimensions of the vehicle 1 compared with the driving configuration, in particular a reduced distance between a rear wheel assembly 5 and a front wheel assembly 6. Not shown in detail is that the vehicle 1 again comprises a vehicle seat 2, which is preferably constructed and arranged in such a way that a driver 8 can be seated on the vehicle seat 2 in the driving configuration and in the transport and/or parking configuration, respectively. In FIG. 5, only the head of the driver 8 is shown.

The vehicle 1 shown in FIG. 5 has a shield 12 to shield the head of the driver 8 from the environment. In the embodiment shown, the shielding 12 is designed as a helmet-like head protection or as a hood-like head protection, in particular with a linkage, and serves essentially to shield the head and, preferably, the neck and adjacent parts of the upper body from the environment. When seated, the driver 8 leans here against a backrest 10 of the vehicle seat 2. Grab handles 19 may be provided for holding onto the vehicle seat 2. Transverse planar shielding elements, which are not shown in FIG. 5, can be provided to protect the legs of the driver 8 towards the front and sides. The shielding elements may be held on a frame part 20, which is formed, for example, by a tubular profile or a plurality of tubular profiles connected to the vehicle frame. The shielding elements may also be connected by castings.

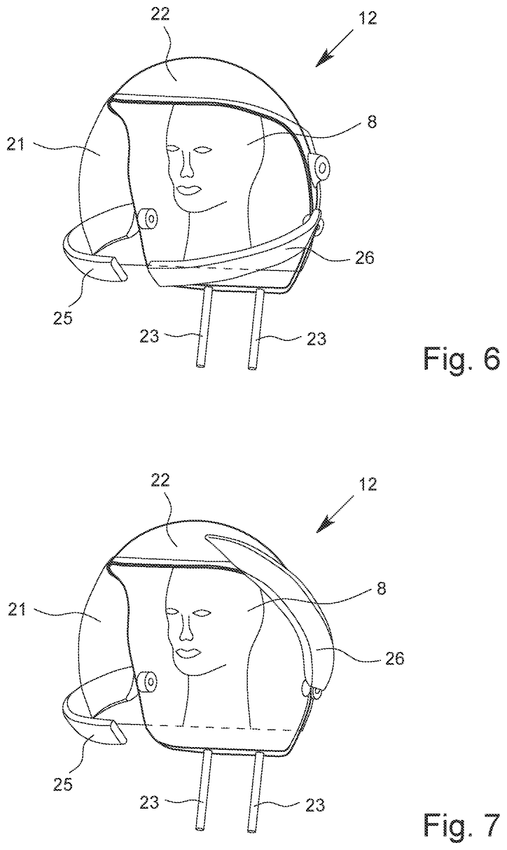

The shield 12 has a foldable or slidable visor 21 substantially shielding the face. The visor 21 is movably connected to a head part 22 of the shielding 12. The head part 22 can be fixedly connected to the vehicle 1, for example via two threaded rods 23 (FIGS. 6 to 9), which can be inserted from above into the backrest 10 or also into a headrest of the vehicle seat 2 and anchored there.

Further preferably, the shield 12 may be detachably connected to the vehicle 1.

FIGS. 5 through 9 show the shield 12 in various configurations. A non-function configuration may refer to a state in which the visor 21 is raised (FIG. 9). Different functional configurations in which the visor 21 is folded down are then shown in FIGS. 5 to 8. A non-functional configuration may also refer to a condition in which the shielding 12 is separated from the vehicle seat 2. When not in use, the shield 12 may be removed from the seatback 10 and stored in a box 24, for example.

The head part 22 serves to protect the back of the head and the upper head area and, preferably, areas of the side portions of the head. A contact surface for the back of the head of the driver 8 may be formed in the head part 22, so that the head part 22 forms the headrest of the vehicle seat 2.

As can be seen from FIGS. 6 to 9, the helmet-like shielding is dimensioned in such a way that free movement of the head is ensured even in the functional configuration of the shielding 12, i.e. with the visor 21 closed. The interior space of the shielding 12, which is delimited by the head part 22 and the visor 21, is selected to be correspondingly large. This ensures a high level of comfort. In particular, it is possible for the driver 8 to turn his head unhindered to the left or to the right in the functional configuration of the shielding 12.

The shield has two movable brackets 25, 26 as an edge boundary for the visor 21, which are pivotably attached to the head part 22 and can be swung open independently of one another. In particular, a multimedia device, in particular a hands-free device, can be integrated in the brackets 25, 26.

Furthermore, the head part 22 may be connectable or connected to the vehicle 1, in particular the vehicle seat 2, so as to be rotatable about a vertical axis and/or vertically adjustable in height. This makes it possible, in particular, to adjust the height of the shield 12 as a function of the height of the driver 8.

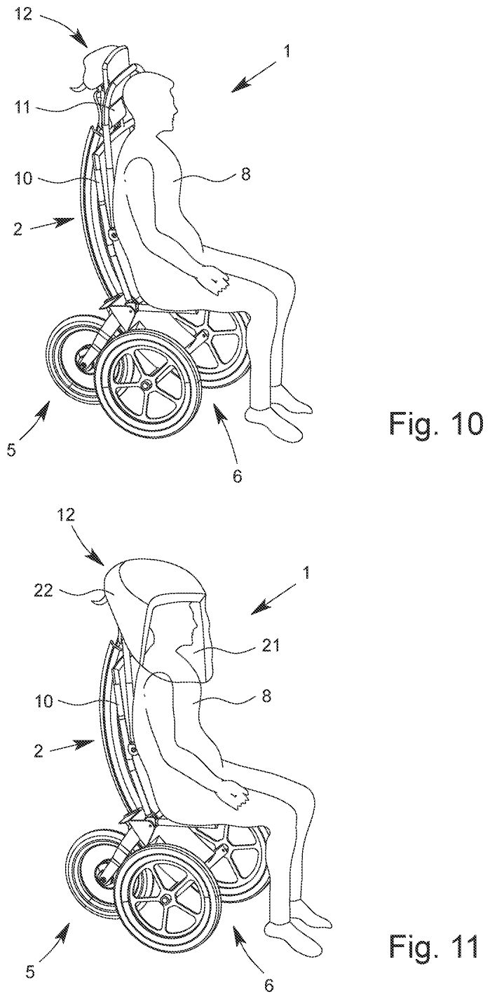

FIGS. 10 and 11 show another embodiment of a vehicle 1 that may have a similar or the same body as the vehicle 1 shown in FIGS. 1 to 4. In FIGS. 10 and 11, the vehicle 1 is shown in a transport and/or parking configuration in which a rear wheel assembly 5 and a front wheel assembly 6 are moved or pushed together and the distance between the rear wheel assembly 5 and the front wheel assembly 6 is less than in a driving configuration of the vehicle 1 that may be shown, for example, in FIGS. 1 to 4.

In the vehicle 1 shown in FIGS. 10 and 11, a shielding 12 is again provided, which is designed as a flexible, in particular reversibly inflatable hood. FIG. 10 shows the hood in a non-inflated, folded state in which the shielding 12 can be integrated into a storage space in the vehicle seat 2, in particular in the area of a headrest of the vehicle seat 2. FIG. 10 thus shows the shield 12 in a non-functional configuration.

To transfer the shield 12 to the functional configuration shown in FIG. 11, the driver 8 removes the shield 12 from the storage space formed on and/or in the vehicle seat 2 and may then inflate the shield 12 himself or an air compressor or electric blower may be provided to inflate the shield 12 mechanically. After use, the shielding 12 may be returned to its non-functional configuration by deflating and stowed. The shielding 12 may be stowable behind the vehicle seat 2 at the level of the headrest 11.

Parts of the shield 12 may form a head portion 22 and a transparent visor 21. In particular, the shielding 12 is formed of or comprises at least one plastic material.

List of reference signs:

| | |
|---|---|
| 1 | Vehicle |
| 2 | Vehicle seat |
| 3 | Rear wheel |
| 4 | Front wheel |
| 5 | Wheel assembly |
| 6 | Wheel assembly |
| 7 | Treadle drive |
| 8 | Driver |
| 9 | Seating surface |
| 10 | Backrest |
| 11 | Headrest |
| 12 | Shielding |
| 13 | Shielding part |
| 14 | Shielding part |
| 15 | Shielding part |
| 16 | Guide rail |
| 17 | Guide rail |
| 18 | Holding bracket |
| 19 | Holding handle |
| 20 | Frame part |
| 21 | Sight |
| 22 | Headboard |
| 23 | Screw rod |
| 24 | Box |
| 25 | Hanger |
| 26 | Hanger |

1. A vehicle, in particular a light vehicle, the vehicle comprising:
at least one vehicle seat, preferably only one vehicle seat or only two vehicle seats;
a front wheel structure having at least one wheel;
a rear wheel structure having at least one wheel; and
a drive device for, in particular, motorized movement of the vehicle;
wherein, preferably, the vehicle can be reversibly changed from a driving configuration when the vehicle is being driven into a transport and/or parking configuration with reduced spatial dimensions of the vehicle compared with the driving configuration, in particular a reduced distance between the front wheel structure and the rear wheel structure, and/or the vehicle seat is set up in a driving configuration and in a transport and/or parking configuration for seating a driver on a seat surface of the vehicle seat; and
wherein a shield for a driver is provided and/or can be formed, the shield in a functional configuration shielding the body of the driver upwards and/or to the sides at least in regions from the surroundings when sitting on the vehicle seat.

2. The vehicle according to claim 1, wherein the shield can be reversibly transferred from a non-functional configuration to the functional configuration, the shield having different geometric dimensions in the non-functional configuration than in the functional configuration and/or being arranged differently relative to the driver in the non-functional configuration than in the functional configuration.

3. The vehicle according to claim 1, wherein the shield can be movably, in particular displaceably and/or pivotably, connected to the vehicle, in particular the vehicle seat, and/or in that the shielding can be releasably connected to the vehicle.

4. The vehicle according to claim 2, wherein the shield is arranged in the non-functional configuration in the area behind the driver.

5. The vehicle according to claim 2, wherein the vehicle seat has a receiving space and/or a holding device for at least partially receiving and/or holding the shield in the non-functional configuration of the shield, in particular in and/or on a backrest and/or a headrest of the vehicle seat.

6. The vehicle according to claim 2, wherein the shield is designed in multiple parts and shielding parts of the shield are connected to one another such that they can be displaced and/or pivoted for transfer from the non-functional configuration to the functional configuration, in particular wherein the shield can be extended in a segment-like manner.

7. The vehicle according to claim 1, wherein the shield in the functional configuration forms a canopy over the body of the driver, wherein, preferably, the shield extends in the longitudinal direction of the vehicle from the rear wheel structure to, further preferably, the front wheel structure.

8. The vehicle according to claim 1, wherein the shield is designed as a helmet-like head protection and essentially shields the head and, preferably, neck and, further preferably, parts of the upper body from the environment.

9. The vehicle according to claim 1, wherein the shield has a head part shielding essentially the back of the head and the upper head region of the driver, wherein, preferably, the head part is connected and/or connectable in a stationary manner to the vehicle, in particular to the vehicle seat.

10. The vehicle according to claim 1, wherein the shield is designed as a flexible, in particular reversibly inflatable hood, it being possible, preferably, for the shield, in a non-inflated, folded state, to be integrated into a stowage space in the vehicle seat, in particular into a headrest and/or a backrest.
